(19) United States
(12) Patent Application Publication
(10) Pub. No.: US 2025/0000099 A1
(43) Pub. Date: Jan. 2, 2025

(54) COMPOSITIONS FOR IMPROVING AGRICULTURAL PRODUCTION

(71) Applicant: Environmental Services Pty Ltd, Thomastown, Victoria (AU)

(72) Inventor: Kevin Joyce, Thomastown (AU)

(73) Assignee: Environmental Services Pty Ltd, Thomastown, Victoria, OT (AU)

(21) Appl. No.: 18/886,779

(22) Filed: Sep. 16, 2024

Related U.S. Application Data
(63) Continuation of application No. 17/241,348, filed on Apr. 27, 2021, now abandoned.

(30) Foreign Application Priority Data
Apr. 30, 2020 (AU) 2020901370

(51) Int. Cl. A01N 65/36; A01N 37/02; A01N 37/36; A01N 37/40; A01N 43/08; A01N 59/00; C05D 9/00; C05F 11/02; C05G 3/60; C05G 3/70; C05G 5/20

(52) U.S. Cl. CPC A01N 65/36; A01N 37/02; A01N 37/36; A01N 37/40; A01N 43/08; A01N 59/00; C05D 9/00; C05F 11/02; C05G 3/60; C05G 3/70; C05G 5/20

(57) ABSTRACT

According to the present invention there is provided a composition for treating plant seeds for improvement of germination rate and/or improvement of early stage plant growth wherein the composition comprises at least one bioflavonoid and at least one organic acid. Preferably, the composition includes at least one wetting agent. More preferably, the at least one wetting agent is a natural plant extract. The at least one bioflavonoid may be a natural plant extract. Further, the organic acid may be a naturally produced organic acid.

### FIELD OF THE INVENTION

This invention relates to compositions for improvement of agricultural production and more particularly relates to compositions for enhancing early plant development and increasing rate of seed germination.

### BACKGROUND

With an ever increasing population and stresses of climate change, there is pressure to increase agricultural production for purposes including food, animal fodder and fuel.

One method of increasing agricultural production is to develop new varieties by selective breeding and/or introduce artificial genetic changes to crop plants. Unfortunately, these methods can also involve an increasing failure rate of seed germination, and a lack of ongoing plant development.

Furthermore, traditional agricultural treatments such as pesticides, herbicides or nutrients such as fertilizers have been found to have undesirable side-effects on those ingesting them and therefore there is also pressure to seek less harmful alternatives from consumers. The traditional agricultural treatments, together with other farming methods such as tilling and environment stress from climate due to environment extremes, have been found to cause stress on the soils which consequently also reduce agricultural production.

Examples of the invention seek to solve or at least ameliorate one or more disadvantages of previous agricultural practices including reduce or eliminate use of harmful traditional agricultural treatments or reduce costs of agricultural production, as well as to desirably increase agricultural production and/or improvement of soil health.

The above references to and descriptions of prior proposals or products are not intended to be, and are not to be construed as, statements or admissions of common general knowledge in the art. In particular, the above prior art discussion does not relate to what is commonly or well known by the person skilled in the art, but assists in the understanding of the inventive step of the present invention of which the identification of pertinent prior art proposals is but one part.

### SUMMARY OF THE INVENTION

According to the present invention there is provided a composition for treating plant seeds for improvement of germination rate and/or improvement of early stage plant growth wherein the composition comprises at least one bioflavonoid and at least one organic acid.

Preferably, the composition includes at least one wetting agent. More preferably, the at least one wetting agent is a natural plant extract.

The at least one bioflavonoid may be a natural plant extract. Further, the organic acid may be a naturally produced organic acid.

Preferably, the composition is in the form of a liquid. The composition is present at between 100 to 500 ppm in a topical composition comprising water or other diluting agent. More preferably, the topical composition is suitable for application to seed prior to planting. Alternatively, the topical composition is suitable for application as a seed coating and for storage/transportation purposes when the coating has dried.

The composition preferably comprises:
between 5% to 30% (by weight) bioflavonoid which is a natural plant extract; or
between 20% to 60% (by weight) organic acid which is naturally produced; and/or
between 5% to 20% (by weight) wetting agent which is a natural plant extract.

The above composition percentages are specific for a concentrated formulation. This concentrated formulation may be diluted for spray application.

The at least one bioflavonoid may be selected from the group including: citrus fruit plant extracts, including pomelo, grapefruit, lemon, lime, orange, tangerine, bitter orange extract comprising Naringin, Naringenin, quercetin-3-O-rutinoside, Neohesperidin

The at least one organic acid may be selected from the group including: malic acid, citric acid, lactic acid, salicylic acid, Silicic acid, caprylic acid, ascorbic acid and tartaric acid

The at least one wetting agent may be selected from the group including: Naturally extracted Saponins, glycerine.

The composition may include seed or plant treatments including at least one of hormones, bactericides or fungicides.

### DETAILED DESCRIPTION OF THE INVENTION

Preferred embodiments of the present invention are directed to compositions for the general improvement of agricultural production including increasing the success rate of seed germination (if we mention this here does this stop the ability to do a separate seed treatment patent) and/or enhancement of early stage plant development. The compositions preferably comprises at least one bioflavonoid in combination with at least one organic acid. The compositions may also include at least one wetting agent. The applicant has found, by trials as discussed further below, to have significant effect on improvement on agricultural production, particularly increasing the success rate of seed germination and/or enhancement of early stage plant development.

In a first preferred embodiment of the invention, there is a composition which comprises at least one bioflavonoid, at least one organic acid and at least one wetting agent for improvement of seed germination rate and early stage plant development. In particular, it is preferred that the at least one bioflavonoid, the at least one organic acid and the at least one wetting agent are natural plant extracts or naturally produced elements.

As the composition comprises entirely of natural plant extracts and organic acids there is no toxicity at recommended topical application dilution levels. The naturally extracted components of the compositions may be found on lists, such as the USDA GRAS list which is generally recognised as safe levels for food or dietary supplements. Specifically the safe levels as recommended by the USDA GRAS list are much higher doses than the levels of the composition in a topical application dilution level. Thus the compositions are much more acceptable to consumers who prefer and demand less harmful agricultural additives to those currently used in traditional agricultural methods.

The applicant has discovered that when plant seeds have been treated with said composition, the composition effects noticeable improvement of germination rate and plant development particularly in new plant varieties which have been selectively bred or which have been genetically modified. This is especially important for food crops and other important plant types.

The applicant has conducted trials which suggests that the composition appears to raise the levels of polyphenols in the treated seeds thereby overcoming latent flaws in the seed genetics which causes full germination to fail and therefore the composition raises the success rate of germination. Therefore, the embodiments of the present invention advantageously compensate for genetic failures in seed production, particularly in those plant varieties which have been genetically bred or modified and where the germination rate has been compromised. Consequently there is a minimisation of crop loss and reduction in cost of unproductive plantings.

In a preferred embodiment, the composition is in a liquid form. The composition is able to be easily produced into a topical composition by being diluted with a diluting agent such as water. In a particularly preferred embodiment, the composition is present at between 10 to 500 ppm when diluted in water. In a specific embodiment of the present invention, the composition is present at between 25 ppm, when diluted in water.

The applicant has found that the topical composition is effective at very dilute levels as specified above and is absorbed by the seed, which keeps production costs low and also the levels of the composition present there is no toxicity and the levels of the individual components are far lower than those levels considered safe as recommended by the USDA GRAS list.

The topical composition can be used as a seed coating by dipping or spraying the plant seeds. The topical composition can also be applied on the plant seeds to form seed coatings before germination. Alternatively, the seeds can be coated and, when the coating has dried, the coating provides benefits in extending shelf life of the seeds for storage or transport by inhibiting pathogens such as fungi and bacteria.

The applicant has found an increase in germination rate to 100% of Solanaceae family (tomato) and Poaceae Family (corn) when seeds are treated with the topical composition. Further, the applicant has found that treated seeds, once germinated, resulted in seedlings which developed significantly larger root mass and vegetative growth within a given time frame when compared to an untreated control group. Specifically, the applicant observed an increase in early plant development of up to 30% from germination of treated seeds when measured against control seedlings in the Ateraceae family (Lettuce) and Poaceae family (corn).

The below table shows trials conducted on seeds of Wheat, Canola, Tomato, capsicum and lupins. The results show seed development and germination rates for untreated seeds ad for seeds treated with different amounts of formulation

Tomatoes

| | | | | | | |
|---|---|---|---|---|---|---|
| CBL Seed | Untreated | <0.5 | ml | .5-1 | ml | Both treatments combined |
| treatment mls | | | | | | with commercial seed |
| per litre | | | | | | fungicide. |

| | | | |
|---|---|---|---|
| Normal seed | 74% | 88% | 88% |
| development | | | |
| Gemination rate | 98% | 100% | 100% |

Capsicum/Peppers

| CBL mls per | Untreated | CBL @ | | CBL @ | | Both treatments combined |
|---|---|---|---|---|---|---|
| 100 kg of seed | | 50 mls | | 100 mls | | with commercial seed |
| | | | | | | fungicide. |
| Germination | 90% | <0.5 | ml | .05-1 | ml | |
| Rate | | | | | | |

Wheat

| | | | | |
|---|---|---|---|---|
| CBL mls per | Untreated | CBL @ | CBL @ | CBL @ 100 + Commercial |
| 100 kg of seed | | 50 mls | 100 mls | Seed Fungicides |
| Germination | 96% | 97% | 98% | 98-100% |
| Rate | | | | |
| CBL mls per | Untreated | CBL @ | CBL @ | CBL @ 100 + Commercial |
| 100 kg of seed | | 50 ml | 100 mls | Seed Fungicides |
| Sprout length | 26.00 | 45.00 | 32.50 | 52.50 |
| mm | | | | |
| CBL mls per | Untreated | CBL @ | CBL @ | CBL @ 100 + Commercial |
| 100 kg of seed | | 50 ml | 100 mls | Seed Fungicides |
| Root mass, | 0.80 | 0.85 | 0.95 | 1.10 |
| grams 7 days | | | | |
| after planting | | | | |

Canola

| Germination | 82% | | 89% | 91% | |
|---|---|---|---|---|---|
| Rate Trial 1 | | | | | |
| Germination | 1.7 | grams | | 3 | grams |
| Rate Trial 2 | | | | | |
| Root Mass 3-4 | | | | | |
| leaf | | | | | |

| | | |
|---|---|---|
| Yield | 1.5 | 1.72 |
| tonnes/hectare | | |
| seed treatment | | |

Lupins

| | | | |
|---|---|---|---|
| Germination rate | 69% | 75% | 82% |
| Trial 1 | | | |
| Germination | 62% | 78% | 89% |
| Rate Trial 2 | | | |
| Yield in Kg per | 0.99 | | 1.25 |
| 200 plants seed | | | |
| treatment | | | |

In a particularly preferred embodiment, the composition comprises:
between 5% to 30% (by weight) at least one bioflavonoid; or
between 30% to 60% (by weight) at least one organic acid; and/or
between 5% to 20% (by weight) at least one wetting agent.

The applicant has found that this composition for increasing the success rate of seed germination and/or enhancement of early stage plant development can be used on various food crops such as vegetables, fruit and nut trees, turf, and broad acre crops such as canola, soy and wheat.

The at least one bioflavonoid may be selected from the group including: citrus fruit plant extracts, including grapefruit, pomelo, lemon, lime, orange, tangerine, bitter orange extract.

The at least one organic acid may be selected from the group including: malic acid, citric acid, lactic acid, salicylic acid, Silicic acid, caprylic acid, ascorbic acid and tartaric acid.

The at least one wetting agent may be selected from the group including: Naturally extracted Saponins, glycerine.

In a particularly preferred embodiment, the compositions mentioned above can include other seed treatment additives which can provide additional benefits such as inhibiting pathogens or extension of the shelf life of the seeds, such as fungicides, bactericides and the like.

Through-out the specification and claims the word “comprise” and its derivatives is intended to have an inclusive rather than exclusive meaning unless the context requires otherwise.

It will be appreciated by those skilled in the art that many modifications and variations may be made to the methods of the invention described herein without departing from the spirit and scope of the invention.

1. A composition for treating plant seeds for improvement of germination rate and/or improvement of early stage plant growth wherein the composition comprises:
at least one bioflavonoid; and
at least one organic acid.

2. A composition according to claim 1, wherein the composition includes at least one wetting agent.

3. A composition according to claim 2, wherein the at least one wetting agent is a natural plant extract.

4. A composition according to any one of the preceding claims, wherein the at least one bioflavonoid is a natural plant extract.

5. A composition according to any one of the preceding claims, wherein the at least one organic acid is naturally produced.

6. A composition according to any one of the preceding claims being in the form of a liquid.

7. A composition according to any one of the preceding claims, wherein the composition is present at between 100 to 500 ppm in a topical composition comprising water or other diluting agent.

8. A composition according to claim 7, wherein the topical composition is suitable for application to seed prior to planting.

9. A composition according to claim 7, wherein the topical composition is suitable for application as a seed coating and for storage/transportation purposes when the coating has dried.

10. A composition according to any one of the preceding claims, comprising:
between 5% to 30% (by weight) at least one bioflavonoid; or
between 30% to 60% (by weight) at least one organic acid; and/or
between 5% to 20% (by weight) at least one wetting agent.

11. A composition according to any one of the preceding claims, wherein the at least one bioflavonoid is selected from the group including: citrus fruit plant extracts, including grapefruit, lemon, lime, orange, tangerine, pomelo bitter orange extract.

12. A composition according to any one of the preceding claims, wherein the at least one organic acid is selected from the group including: malic acid, citric acid, lactic acid, salicylic acid, Silicic acid, ascorbic acid caprylic acid and tartaric acid.

13. A composition according to any one of the preceding claims when dependent on claim 2, wherein the at least one wetting agent is selected from the group including naturally extracted Saponins, glycerine.

14. A composition according to any one of the preceding claims, wherein the composition includes seed treatments including at least one of hormones, bactericides or fungicides.
